(19) United States
(12) Patent Application Publication
(10) Pub. No.: US 2020/0373112 A1
(43) Pub. Date: Nov. 26, 2020

(54) THERMALLY PROTECTED VARISTOR

(71) Applicant: XIAMEN SET ELECTRONICS CO., LTD, Xiamen (CN)

(72) Inventors: Zhonghou XU, Xiamen (CN); Shi CHEN, Xiamen (CN); Feilong CHEN, Xiamen (CN); Xiangzhou CHEN, Xiamen (CN)

(73) Assignee: XIAMEN SET ELECTRONICS CO., LTD, Xiamen (CN)

(21) Appl. No.: 16/767,126

(22) PCT Filed: May 9, 2018
(86) PCT No.: PCT/CN2018/086142

§ 371 Date: May 27, 2020

(30) Foreign Application Priority Data
Dec. 15, 2017 (CN) 201721762171.3

(51) Int. Cl. H01H 85/02; H01H 85/20; H01H 85/30; H01C 7/10

(52) U.S. Cl. CPC H01H 85/0241; H01H 85/205; H01C 7/10; H01H 85/30; H01H 85/2045

(57) ABSTRACT

A thermally protected varistor includes a varistor chip, a temperature fuse, and a lead line, wherein the varistor chip includes a first conductive layer and a second conductive layer, and the lead line includes a first lead line, a second lead line, and a third lead line. One end of the first lead line is connected to the first conductive layer, and the other end of the first lead line is led out. A first end of the temperature fuse is led out as the second lead line, and a second end of the temperature fuse is connected to the second conductive layer. One end of the third lead line is connected to the second conductive layer, and the other end of the third lead line is led out. The temperature fuse is an axial temperature fuse and is tightly attached to the varistor chip.

### CROSS REFERENCE TO THE RELATED APPLICATIONS

This application is the national phase entry of International Application No. PCT/CN2018/086142, filed on May 9, 2018, which is based upon and claims priority to Chinese Patent Application No. 201721762171.3, filed on Dec. 15, 2017, the entire contents of which are incorporated herein by reference.

### TECHNICAL FIELD

The present invention relates to a varistor, and in particular to a thermally protected varistor.

### BACKGROUND

At present, all kinds of home appliances have become an indispensable part of people's daily life. When we enjoy the convenience of various home appliances with a variety of functions to life, there are also huge security risks for home appliances. We can often see various accidents caused by the safety problems of home appliances in domestic and foreign media, mainly including smoke, fire, and even explosions. Most of these accidents are related to the failure to disconnect the circuit in time after the varistor fails. The current varistor with a thermal protection function has relatively slow heat conduction when the varistor is degraded and a high temperature occurs, so that the circuit cannot be disconnected in time, resulting in the occurrence of a fire hazard; or because the varistor has a relatively large volume and a high manufacturing method cost, it is not suitable for small power supply. The thermally protected varistor provided by the present invention has the characteristics of small volume, fast response speed, high reliability, etc, which can be widely used in the fields of home appliances, power adapters, circuit overvoltage protection for driving power supply, etc., and can replace the unprotected varistors currently widely used in these application fields.

### SUMMARY

The technical problem to be solved by the present invention is to provide a thermally protected varistor, which is small in volume, fast in response speed and high in reliability, and can be widely applied to various fields.

In order to solve the above technical problem, a thermally protected varistor of the present invention includes a varistor chip, a temperature fuse, and a lead line, wherein the varistor chip includes a first conductive layer and a second conductive layer, and the lead line includes a first lead line, a second lead line and a third lead line; one end of the first lead line is connected to the first conductive layer, and the other end of the first lead line is led out; a first end of the temperature fuse is led out as the second lead line, and a second end of the temperature fuse is connected to the second conductive layer; one end of the third lead line is connected to the second conductive layer, and the other end of the third lead line is led out; and the temperature fuse is an axial temperature fuse and is tightly attached to the varistor chip. The connection referred to herein includes but is not limited to welding commonly used in the art. The first end of the temperature fuse mentioned herein refers to a first end lead line of the temperature fuse, and the second end of the temperature fuse refers to a second end lead line of the temperature fuse.

Preferably, the varistor chip is square.

Preferably, the third lead line and the temperature fuse are connected to different positions of the second conductive layer.

Preferably, the third lead line and the temperature fuse are soldered to each other and are connected to the same position of the second conductive layer.

Preferably, a welding place of the third lead line and the temperature fuse is flat, which increases the contact area of the connection with the varistor chip and improves the sensitivity of heat conduction.

Preferably, the second end of the temperature fuse is integrated with the third lead line, that is, when the second end of the temperature fuse is long enough, the second end lead line is directly used as the third lead line, and meanwhile, the second end lead line is welded to the second conductive layer and is led out as a pin. Preferably, the third lead line obliquely crosses the upper surface of the varistor chip and is tightly attached to upper surface of the varistor chip, so as to transmit the temperature of the varistor more accurately and quickly.

Preferably, the second lead line is directly led out in a straight line.

Preferably, the second lead line is led out at a right angle around two adjacent side surfaces of the varistor chip.

Preferably, a packaging material covers the varistor chip and the temperature fuse, and the lead line is led out from the packaging material as a pin. Specifically, the first lead line, the second lead line, and the third lead line are led out from the packaging material into three pins, respectively.

Preferably, the packaging material is provided with a visible window on the temperature fuse, and an insulating outer casing is transparent or translucent, and a state of a fusible alloy can be observed through the window.

Preferably, a casing is arranged at an outside of the packaging material, and the casing can make a product without fire hazard on a surface of the product in the process of the breakdown failure of the metal oxide varistor (MOV) under abnormal overvoltage to disconnection of the temperature fuse.

Preferably, a thermally insulating member is arranged between the packaging material and the casing, and the thermally insulating body may be an inorganic material such as sandstone, an organic material commonly used for thermally insulating, or the like.

Preferably, the varistor chip includes an upper end surface, a lower end surface opposite to the upper end surface in a thickness direction, and a side end surface connecting the upper end surface and the lower end surface; and the temperature fuse is tightly attached to the side end surface of the varistor chip. This arrangement minimizes the volume of the thermally protected varistor without increasing the thickness of the entire product.

The advantages of the present invention are as follow:

1. The thermally protected varistor of the present invention can more effectively and accurately transfer the heat generated by the varistor chip to the temperature fuse when the varistor chip is abnormal, thereby shortening the time required by the temperature fuse for disconnecting the circuit.

2. The thermally protected varistor is small in volume and easy to install.

3. The thermally protected varistor is based on the prior structure of the varistor chip, and is simple in structure, easy to manufacture, and low in cost.

### BRIEF DESCRIPTION OF THE DRAWINGS

FIG. 1 is a schematic diagram showing the structure of a thermally protected varistor according to Embodiment 1 of the present invention;

FIG. 2 is a schematic diagram showing the structure of a thermally protected varistor according to Embodiment 2 of the present invention; and

FIG. 3 is a schematic diagram showing the structure of a thermally protected varistor according to Embodiment 3 of the present invention.

In the figures:
1. Varistor chip
11. First conductive layer
12. Second conductive layer
2. Temperature fuse
21. Fusible alloy
22. Fluxing agent
23. Insulating outer casing
24. Sealing resin
3. Packaging material
4. Lead line
41. First lead line
42. Second lead line
43. Third lead line

### DETAILED DESCRIPTION OF THE EMBODIMENTS

The present invention is further described in detail below with reference to the embodiments and the accompanying drawings. It should be understood that the specific embodiments described herein are only used to explain the present invention, and should not be regarded as specific limitations on the present invention.

### Embodiment 1

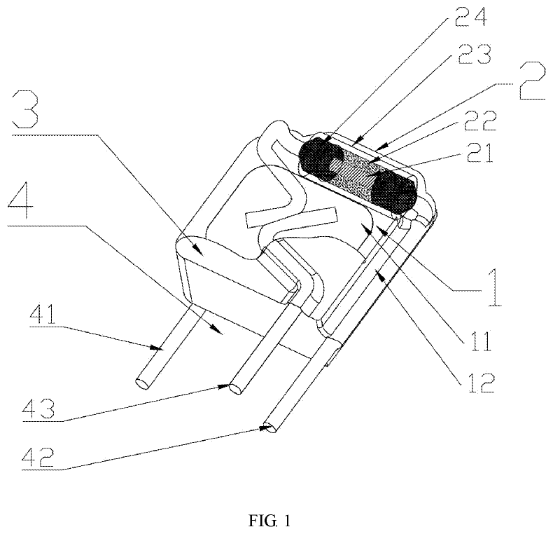

As shown in FIG. 1, a thermally protected varistor includes the square varistor chip 1, and the varistor chip 1 includes the first conductive layer 11 and the second conductive layer 12. The lead line 4 is provided for connecting and leading out, wherein the lead line includes the first lead line 41, the second lead line 42 and the third lead line 43. One end of the first lead line 41 is soldered to the first conductive layer 11 of the varistor chip 1, and the other end of the first lead line 41 is led out as a pin. The axial temperature fuse 2 is tightly attached to an upper end surface of the varistor chip 1, and includes the fusible alloy 21. The fluxing agent 22 is coated on the outside of the fusible alloy 21. The fusible alloy 21 and the fluxing agent 22 are wrapped by the insulating outer casing 23 made of glass. The insulating outer casing 23 is sealed with the sealing resin 24. The first end of the temperature fuse 2 extends at a right angle along a right side end surface of the varistor chip 1 as the second lead line 42, and extends out from a lower side surface of the varistor chip 1 as a pin. This arrangement can increase the length of the second electrode 42 led out from the temperature fuse 2 without increasing the volume of the product. In this way, the safety of the product through wave soldering can be improved. The second end of the temperature fuse 2 and the third lead line 43 are welded together, and are welded to the second conductive layer 12 together.

The packaging material 3 covers the varistor chip 1 and the temperature fuse 2, and is provided with a notch at the temperature fuse 2 as a visible window. The temperature fuse can be directly observed through the notch, and the conditions of the fusible alloy 21 are observed through the transparent insulating outer casing. The first lead line 41, the second lead line 42 and the third lead line 43 are led out from the packaging material 3 as pins, respectively. A current flows from the first lead line 41 through the varistor chip 1 by the first conductive layer 11, and after the current flows out of the second conductive layer 12, a part of the current is led out through the third lead line 43, and a part of the current flows to the temperature fuse 2 and then is led out through the second lead line 42.

### Embodiment 2

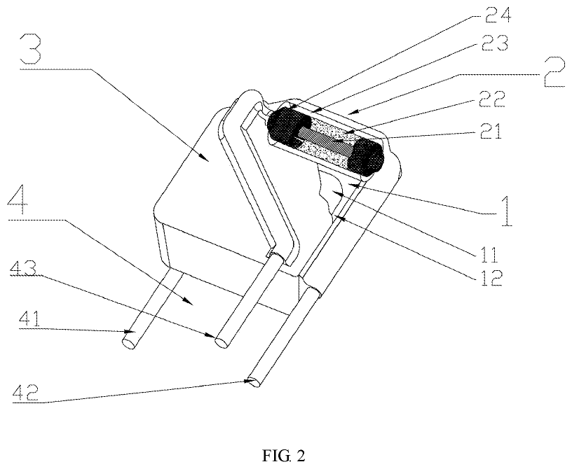

As shown in FIG. 2, the structure of the thermally protected varistor is substantially similar to that of Embodiment 1, except that the second end of the temperature fuse 2 is integrated with the third lead line 43. The third lead line 43 obliquely crosses the upper surface of the varistor chip 1 and is tightly attached to the upper surface of the varistor chip 1.

### Embodiment 3

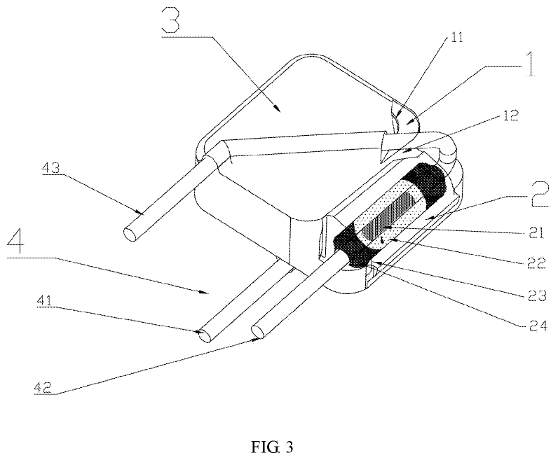

As shown in FIG. 3, the structure of the thermally protected varistor is substantially similar to that of Embodiment 2, except that the temperature fuse 2 is tightly attached to the right end surface of the varistor chip 1. One end of the second lead line 42 is soldered to the temperature fuse 2, and the other end of the second lead line 42 is directly led out of the lower side of the varistor chip 1 in a straight line as a pin.

It should be understood that the above embodiments of the present invention are merely examples for clearly illustrating the present invention, rather than limiting the implementations of the present invention. For those of ordinary skill in the art, based on the above description, other variations or changes in different forms can also be made. It is not possible to exhaustively list all implementations herein. Any obvious variations or changes derived from the technical solutions of the present invention shall fall within the scope of protection of the present invention.

What is claimed is:

1. A thermally protected varistor, comprising a varistor chip, a temperature fuse, and a lead line, wherein the varistor chip comprises a first conductive layer and a second conductive layer, and the lead line comprises a first lead line, a second lead line and a third lead line; a first end of the first lead line is connected to the first conductive layer, and a second end of the first lead line is led out; a first end of the temperature fuse is led out as the second lead line, and a second end of the temperature fuse is connected to the second conductive layer; a first end of the third lead line is connected to the second conductive layer, and a second end of the third lead line is led out; and the temperature fuse is tightly attached to the varistor chip.

2. The thermally protected varistor according to claim 1, wherein, the varistor chip is square.

3. The thermally protected varistor according to claim 1, wherein, the third lead line and the temperature fuse are connected to different positions of the second conductive layer.

4. The thermally protected varistor according to claim 1, wherein, the third lead line and the temperature fuse are soldered to each other and are connected to a same position of the second conductive layer.

5. The thermally protected varistor according to claim 4, wherein, a welding place of the third lead line and the temperature fuse is flat.

6. The thermally protected varistor according to claim 1, wherein, the second end of the temperature fuse is integrated with the third lead line.

7. The thermally protected varistor according to claim 1, wherein, the second lead line is directly led out in a straight line.

8. The thermally protected varistor according to claim 1, wherein, the second lead line is led out at a right angle around two adjacent side surfaces of the varistor chip.

9. The thermally protected varistor according to claim 1, wherein, a packaging material covers the varistor chip and the temperature fuse, and the lead line is led out from the packaging material as a pin.

10. The thermally protected varistor according to claim 9, wherein, the packaging material is provided with a visible window on the temperature fuse, an insulating outer casing is transparent or translucent, and a state of a fusible alloy is observed through the visible window.

11. The thermally protected varistor according to claim 9, wherein, a casing is arranged at an outside of the packaging material.

12. The thermally protected varistor according to claim 11, wherein, a thermally insulating member is arranged between the packaging material and the casing.

13. The thermally protected varistor according to claim 1, wherein, the varistor chip comprises an upper end surface, a lower end surface opposite to the upper end surface in a thickness direction, and a side end surface connecting the upper end surface and the lower end surface; and the temperature fuse is tightly attached to the side end surface of the varistor chip.

14. The thermally protected varistor according to claim 2, wherein, the third lead line and the temperature fuse are connected to different positions of the second conductive layer.

15. The thermally protected varistor according to claim 2, wherein, the third lead line and the temperature fuse are soldered to each other and are connected to a same position of the second conductive layer.

16. The thermally protected varistor according to claim 2, wherein, the second end of the temperature fuse is integrated with the third lead line.

17. The thermally protected varistor according to claim 2, wherein, the second lead line is directly led out in a straight line.

18. The thermally protected varistor according to claim 2, wherein, the second lead line is led out at a right angle around two adjacent side surfaces of the varistor chip.

19. The thermally protected varistor according to claim 2, wherein, a packaging material covers the varistor chip and the temperature fuse, and the lead line is led out from the packaging material as a pin.

20. The thermally protected varistor according to claim 1, wherein, the temperature fuse is an axial temperature fuse.
